(19) United States
(12) Patent Application Publication
(10) Pub. No.: US 2026/0340846 A1
(43) Pub. Date: Oct. 29, 2026

(54) SYSTEM AND METHOD FOR BRINGING A VIRTUAL 3D MODEL INTO REGISTER THROUGH DISPLAY IN SEE-THROUGH

(71) Applicants: SURGAR, CLERMONT-FERRAND (FR); UNIVERSITÉ CLERMONT-AUVERGNE, CLERMONT-FERRAND (FR); CENTRE NATIONAL DE LA RECHERCHE SCIENTIFIQUE, Paris (FR); CLERMONT AUVERGNE INP, Aubière (FR); CENTRE HOSPITALIER UNIVERSITAIRE DE CLERMONT-FERRAND, CLERMONT-FERRAND (FR)

(72) Inventors: Adrien BARTOLI, Clermont-Ferrand (FR); Robin DOUSSE, lermont-Ferrand (FR); Lilian CALVET, Toulouse (FR); Prasad SAMARAKOON, Romagnat (FR)

(73) Assignees: SURGAR, CLERMONT-FERRAND (FR); UNIVERSITÉ CLERMONT-AUVERGNE, CLERMONT-FERRAND (FR); CENTRE NATIONAL DE LA RECHERCHE SCIENTIFIQUE, Paris (FR); CLERMONT AUVERGNE INP, Aubière (FR); CENTRE HOSPITALIER UNIVERSITAIRE DE CLERMONT-FERRAND, CLERMONT-FERRAND (FR)

(21) Appl. No.: 19/111,533

(22) PCT Filed: Sep. 12, 2023
(86) PCT No.: PCT/EP2023/075046

§ 371 Date: Mar. 13, 2025

(30) Foreign Application Priority Data
Sep. 13, 2022 (FR) FR2209161

(51) Int. Cl. G06T 7/33; G06T 7/00

(52) U.S. Cl. CPC G06T 7/344; G06T 7/0012; G06T 2207/10068; G06T 2207/30004

(57) ABSTRACT

The invention relates to a method for registration of a virtual three-dimensional model of a target organ, called 3D model, with at least one image of said target organ in a scene obtained by an endoscope (12), comprising in particular a step of predicting a position and orientation of the target organ with respect to the scene, a step of superimposing, on at least one current image from the endoscope, a projection with semi-transparency of the 3D model based on the predicted position and orientation, on a display device (18), a step of receiving a command indicating an alignment between the projection with semi-transparency of the 3D model and the image of the target organ on the current image and a step of calculating the position and orientation of the target organ on the current image with respect to the scene.

### TECHNICAL FIELD OF THE INVENTION

The invention relates to a system and a method for registration of a 3D model on an optical image. In particular, the invention relates to the registration of a virtual 3D model of an organ obtained from preoperative imaging to an image of the organ obtained by optical imaging, in particular stereoscopic or monocular endoscopic imaging. The invention can be used in particular in a laparoscopic imaging and robotics context.

### TECHNOLOGICAL BACKGROUND

Registration, also called “alignment”, is an operation making it possible to achieve a match in terms of position and orientation between a virtual 3D model of an object and an optical image of the same object obtained by a camera. In particular, the aim is to determine the transformation (change in coordinate frame and deformation) which must be effected so that the 3D model of the object and the image of the object having distinct coordinate systems and distinct states are aligned. In practice, the knowledge of this transformation from the registration makes it possible to display, in an augmented reality context, the virtual 3D model, from pre-calculated data, on the image obtained by the camera, representing the real world. The aim is then to ensure the tracking of the object on the image to display the 3D model thereon, after registration.

In particular, the methods for registration are implemented in the medical and/or surgical field to map a 3D model, called a preoperative model because it is obtained upstream from one or more medical imaging techniques (e.g. radioscopy, ultrasound, MRI, CT, etc.) with a real image obtained by an optical camera, for example an endoscope.

The methods for registration are generally divided into two main categories: initialization methods which aim to provide rapid registration with a relatively low precision so as to provide an initial registration solution, and refining methods which make it possible to improve an earlier registration, the first registration typically being obtained by an initialization method. The refining methods also allow adaptation to a modification to the shape or position of the object to be tracked.

There is a complexity involved with the initialization methods, i.e. the absence of a precise idea regarding the transformation to be implemented because it is this method which must provide the first registration transformations. The known initialization methods can be classed into two categories: automatic methods and manual methods.

The automatic methods use, for example, visual indices and descriptors or automatic matches to automatically calculate the registration. These methods have variable results, and in a medical and/or surgical context must be systematically validated or corrected by an operator. These automatic methods are also difficult to implement when the 3D model has no texture and is only a shape because few visual indices are available, which is generally the case for the preoperative 3D model.

The existing manual methods can be classed into several sub-categories:
methods requiring interactive manipulation of the preoperative 3D model, making it possible, owing to the use of a user interface, to apply the transformations to the 3D model until alignment with the object appearing on the image of the camera;
methods requiring interactive selection of known area, curve or point matches on the image of the object obtained by the camera and on the 3D model.

These methods have a number of disadvantages.

The methods requiring manipulation of the model require action to be taken on the rotation, position and possibly scale of the 3D model, which can be very complicated, even for an experienced person: some objects have several axes of symmetry which complicate the operation, determining a good match between scale and depth can be complicated, the object may only be partially visible, etc.

The methods with matching points can be difficult to implement if said matching points are difficult to identify, if the colors of the object seen on the image and the 3D model are different, etc.

Furthermore, in a medical or surgical context these methods require intervention by the operator on an external computing device which can present problems in terms of hygiene or sterilization. This intervention also results in a distraction for the operator who must move his attention away from the patient and to the external device.

The inventors have thus sought to provide a method for registration for the initialization making it possible to simplify the interaction by the operator and to limit the risks of initialization errors common in the existing methods. The proposed method for registration would form a new sub-category of manual methods.

### AIMS OF THE INVENTION

The invention aims to provide a system and a method for registration of a 3D model of a target organ on at least one image of said organ obtained by an endoscope-type camera.

The invention aims to provide, in at least one embodiment, a system and a method for registration making it possible to simplify the initialization of the registration whilst obtaining a robust result.

The invention aims to provide, in at least one embodiment, a system and a method for registration which can be used for the registration of a 3D model on an image obtained by an endoscope.

The invention aims to provide, in at least one embodiment, a system and a method for registration which do not require intervention on a computing device external to the medical and/or surgical intervention.

### DESCRIPTION OF THE INVENTION

For this purpose, the invention relates to a method for registration of a virtual three-dimensional model of a target organ, called 3D model, with at least one image of said target organ in a scene obtained by an endoscope, comprising:
a step of receiving the 3D model of the target organ,
a step of predicting a position and orientation of the target organ with respect to a reference coordinate frame of the scene in which the position and orientation of the endoscope are known, based on a reference position and orientation of the endoscope with respect to the scene,
a step of simulating a position and orientation of the 3D model based on said predicted position and said predicted orientation of the target organ,
a step of displaying at least one current image from the endoscope on a display device,
a step of superimposing, on at least one current image from the endoscope, a projection with semi-transparency of the 3D model based on the predicted position and orientation, on the display device, said projection being fixed with respect to the endoscope,
a step of receiving a command indicating an alignment between the projection with semi-transparency of the 3D model and the image of the target organ on the current image,
a step of calculating the position and orientation of the target organ on the current image with respect to the reference coordinate frame.

A method for registration in accordance with the invention thus makes it possible to facilitate the initialization of the registration by proposing a solution making it possible to display, with semi-transparency, a projection of the virtual 3D model with respect to a predicted and predefined reference position and orientation such that the user manipulates the endoscope until the projection of the 3D model is aligned with the target organ. The operator can then indicate that the alignment is complete by interacting with a validation means, for example a physical validation interface or a graphical validation interface. These actions allow the user to concentrate on viewing the displayed image and managing the endoscope whilst remaining focused on the real world, the patient, without having to manipulate a virtual 3D model on an external system. The physical validation interface is for example a button actuated by the hand of the operator or a pedal actuated by the foot of the operator. In accordance with another variant of the invention, the validation means comprises an automatic validation module making it possible to automatically test the alignment of the projection of the 3D model with the targeted organ, and making it possible to suggest to a user that the alignment is correct and/or to send the command indicating an alignment between the projection with semi-transparency of the 3D model and the image of the target organ on the current image.

The command indicating the alignment makes it possible to calculate the position and orientation of the target organ on the current image with respect to the reference coordinate frame from the position of the endoscope for the current image when the command indicating the alignment is received.

The pairing formed by the position and orientation of an object or of a 3D model is commonly called the pose of this object.

In conventional registration techniques, the operator interacts with the virtual model so that it corresponds to the real world, whereas in the invention the operator interacts with the real world to make it correspond to the virtual model. The operation can be effected without direct interaction with hardware not used in medical and/or surgical routine, and thus very naturally by the operator.

The method is also particularly suitable when the target organ as seen on the current image and the 3D model of the target organ have distinct states, i.e. when they have different shapes, in particular because a deformation is applied to the model or to the target organ as seen on the current image. The method for registration operates to calculate the pose even in the presence of deformations in contrast to the majority of the methods of the prior art.

The predicted position and orientation are related to a prior knowledge of the scene and of the reference position and orientation of the endoscope with respect to the target organ. The predicted position and orientation can thus be calculated or pre-calculated, manually or automatically, and remain fixed during the rest of the method for registration. For example, in the context of laparoscopy the endoscope is arranged at a standard position and orientation relatively identical for each laparoscopy procedure and the position of the 3D model can thus be adjusted based on this standard position and orientation. Several reference position and orientation pairings can be pre-calculated in order to be adapted to several possible configurations. For example, the endoscope can be arranged at different entry points depending upon the type of intervention, the target organ and possibly the pathology to be treated.

The reference coordinate frame is for example a coordinate frame of the endoscope which makes it possible to easily define a fixed transformation of the 3D model in order to obtain the projection of the fixed 3D model in the current image. Other coordinate frames can be used if the transformation of this coordinate frame to the endoscope model is known or can be calculated.

The current image can be a 2D image or a stereoscopic image according to variants of the invention.

Within the scope of a medical or surgical procedure, the steps of receiving the 3D model of the target organ, predicting a position and orientation of the target organ and simulating a position and orientation of the 3D model can advantageously be performed “preoperatively”, i.e. upstream of the procedure for image capturing. The steps of displaying at least one current image, superimposing a projection with semi-transparency of the 3D model, receiving a command and calculating the position and orientation of the target organ are advantageously performed in parallel with the procedure for image capturing, “peroperatively”.

Advantageously and in accordance with the invention, the method comprises a step of defining a canonical coordinate frame of the 3D model of the organ, said canonical coordinate frame being defined by an origin and three axes, and in that the step of predicting a position and orientation of the target organ makes it possible to define a transformation of the 3D model of the organ between the canonical coordinate frame and the reference coordinate frame.

According to this aspect of the invention, the transformation of the canonical coordinate frame to the reference coordinate frame makes it possible to define the position and orientation of the 3D model in the reference coordinate frame which will be displayed in the current image based on the predicted position and orientation. This step can be performed upstream, i.e. in the preoperative step, before the capturing of images of the target organ by the endoscope.

Advantageously and in accordance with the invention, the target organ is a uterus comprising in particular a fundus of uterus, an anterior wall of the uterus and a cervix, and the canonical coordinate frame is defined by an origin forming the center of mass of a distal part of the uterus, a first left-right axis of the uterus, a second axis connecting a center of mass of the fundus of uterus and a center of mass of the cervix and a third axis which is a scalar product of the first axis and second axis.

According to this aspect of the invention, the method for registration is particularly suitable for the registration of a 3D model of a uterus on a current image of a uterus as the target organ. The particular shape of the uterus allows the definition of a canonical coordinate frame suitable for the implementation of the method for registration.

Advantageously and in accordance with the invention, the step of defining the canonical coordinate frame comprises:
a sub-step of calculating a principal axis of the medial part of the fundus of uterus, called fundus of uterus axis,
a sub-step of calculating a principal axis of the medial part of the anterior wall of the uterus, called anterior wall axis,
a sub-step of calculating the left-right axis of the uterus by the vectorial product of the fundus of uterus axis by the anterior wall axis,
a sub-step of calculating the center of mass of the fundus of uterus,
a sub-step of calculating the center of mass of the cervix,
a sub-step of calculating a plane defined by the plane in which each point is equidistant from the center of mass of the fundus of uterus and the center of mass of the cervix,
a sub-step of determining two parts of the uterus, delimited by the plane, a distal part comprising the fundus of uterus and the anterior wall and a proximal part connected to the cervix,
a sub-step of calculating the center of mass of the distal part.

According to other variants of the invention, the target organ can be an organ other than the uterus and the canonical coordinate frame is determined based on the general shape of this target organ.

For example, the target organ can be a liver (in which the virtual 3D model is generally obtained by CT imaging) or a kidney (in which the virtual 3D model is generally obtained by MRI and/or CT imaging), or even other organs.

When the target organ is a liver or kidney, the canonical coordinate frame can be defined by a center of mass forming the origin and by fixed axes along the principal axes of the 3D model obtained, for example, by principal component analysis of the nodes of the mesh, a first axis extending along the principal axis which is longer and is positioned in parallel with the image plane of the endoscope, horizontal or vertical depending upon the organ in question, a second axis extending along the principal axis which is shorter and faces the endoscope and a third axis which is a scalar product of the first axis and the second axis.

Advantageously and in accordance with the invention, the method comprises a step of pre-calculating the projection of the 3D model from the 3D model and the predicted position and orientation, upstream of the step of superimposing said projection on at least one current image from the endoscope.

According to this aspect of the invention, the projection of the 3D model makes it possible to obtain a simple image in two dimensions which can be easily combined with the current image to create the semi-transparent effect. The projection can be complete but can also consist of a silhouette or a full or partial contour of the target organ.

Advantageously and in accordance with the invention, the method comprises a step of receiving a 3D model generated from images captured by the endoscope, called peroperative 3D model, and in that it comprises a step of calculating the translation and scale factor between the 3D model of the target organ and the peroperative 3D model, comprising:
a sub-step of expressing the 3D model of the target organ and the peroperative 3D model in a common coordinate frame based on the position and orientation of the target organ on the current image with respect to the reference coordinate frame,
a sub-step of selecting an origin point in the common coordinate frame,
a sub-step of generating at least one radius extending from the origin point and extending in the direction of the optical axis of the endoscope,
a sub-step of calculating the distance between the origin and the intersection of each radius with the 3D model of the virtual organ,
a sub-step of calculating the distance between the origin and the intersection of each radius with the peroperative 3D model,
a sub-step of calculating the translation and scale factor from each distance between the origin and intersection of a radius with the 3D model of the virtual organ and each distance between the origin and intersection of said radius with the peroperative 3D model.

According to this aspect of the invention, the calculation of the translation and scale factor makes it possible to ensure the registration of the 3D model of the target organ, called preoperative 3D model, with the target organ as modeled in the model of the scene obtained by the endoscope, called peroperative 3D model. In particular, these steps are relevant if a scale difference exists between the preoperative 3D model and the peroperative 3D model. In fact, the calculation of the position and orientation of the target organ on the current image makes it possible to obtain the registration of the 3D model on said image but does not guarantee the registration of the preoperative 3D model with the target organ in the peroperative 3D model owing to the partial knowledge of the depth and spacing on the basis of a single image. The steps of calculating the translation and scale factor allow the complete registration of the preoperative 3D model with the peroperative 3D model by mapping coordinate frames associated with each model, in particular by making it possible to use a metric coordinate frame for each model making it possible to know the dimensions of each object in each 3D model.

The use of several radii and associated distances make it possible to accentuate the precision of the calculation, for example using the median or mean of the calculated distances.

Advantageously and in accordance with the invention, the method comprises the acquisition of several images and a step of selecting, from among the images, an image with greater quality than the other images for the registration of the 3D model.

According to this aspect of the invention, the acquisition of several images, for example via the acquisition of a short video extract, makes it possible to guarantee the acquisition of at least one image of sufficient quality to be able to be used as the key image for the generation of the peroperative 3D model, and the tracking of the 3D model of the target organ with respect to this peroperative 3D model.

The invention also relates to a system for registration of a virtual three-dimensional model of a target organ with an image of said target organ, comprising:
an endoscope, configured to capture said image,
a display device, configured to display said image,
a validation means, configured to provide a command indicating an alignment between a projection with semi-transparency of the 3D model and the image of the target organ,
a processing unit,
the processing unit comprising:
a module for receiving the 3D model of the target organ,
a module for predicting a position and orientation of the target organ with respect to a reference coordinate frame of the scene in which the position and orientation of the endoscope are known, based on a reference position and orientation of the endoscope with respect to the scene,
a module for simulating a position and orientation of the 3D model based on said predicted position and said predicted orientation of the target organ,
a module for displaying at least one current image from the endoscope on a display device,
a module for superimposing, on at least one current image from the endoscope, a projection with semi-transparency of the 3D model based on the predicted position and orientation, on the display device, said projection being fixed with respect to the endoscope,
a module for receiving a command indicating an alignment between the projection with semi-transparency of the 3D model and the image of the target organ on the current image,
a module for calculating the position and orientation of the target organ on the current image with respect to the reference coordinate frame.

A system for registration in accordance with the invention allows the display of the projection of the 3D model on at least one current image and the reception of the command indicating the alignment of the projection of the 3D model with the target organ on the current image. The information relating to the alignment of the projection of the 3D model with the target organ on the current image allows the calculation of the position of the target organ in the current image and therefore the registration of the 3D model of the target organ with its image in the current image and in the future images captured by the endoscope.

A module can consist, for example, of a computing device such as a computer, a group of computing devices, an electronic component or a group of electronic components, or, for example, a computer program, a group of computer programs, a library of a computer program or a function of a computer program executed by a computing device such as a computer, a group of computing devices, an electronic component or a group of electronic components.

The validation means can preferably be a physical validation interface with the operator and can, for example, comprise a physical button, a lever, a pedal intended to be actuated by a foot of an operator, etc. The pedal allows interaction by the operator without using his hands. The validation means can also be a graphical validation interface. The validation means can also be without any physical contact, for example with a sensor making it possible to detect a motion of the operator or to detect an audible command. Finally, the validation means can also be automatic, in particular can comprise a validation module allowing automatic processing of the images and automatic detection of the alignment between the projection with semi-transparency of the 3D model and the image of the target organ on the current image, so as to suggest to the user that the alignment is complete or to directly send the command indicating such an alignment.

Advantageously, the system for registration in accordance with the invention is configured to implement the method for registration in accordance with the invention.

Advantageously and in accordance with the invention, the method for registration in accordance with the invention is configured to be implemented by a system for registration in accordance with the invention.

Advantageously and in accordance with the invention, the processing unit comprises a module for defining a canonical coordinate frame of the 3D model of the organ, said canonical coordinate frame being defined by an origin and three axes, and in that the module for predicting a position and orientation of the target organ makes it possible to define a transformation of the 3D model of the organ between the canonical coordinate frame and the reference coordinate frame.

Advantageously and in accordance with the invention, the target organ is a uterus comprising in particular a fundus of uterus, an anterior wall of the uterus and a cervix, and the canonical coordinate frame is defined by an origin forming the center of mass of a distal part of the uterus, a first left-right axis of the uterus, a second axis connecting a center of mass of the fundus of uterus and a center of mass of the cervix and a third axis which is a scalar product of the first axis and second axis.

Advantageously and in accordance with the invention, the module for defining the canonical coordinate frame is configured for:
calculating a principal axis of the medial part of the fundus of uterus, called fundus of uterus axis,
calculating a principal axis of the medial part of the anterior wall of the uterus, called anterior wall axis,
calculating the left-right axis of the uterus by the vectorial product of the fundus of uterus axis by the anterior wall axis,
calculating the center of mass of the fundus of uterus,
calculating the center of mass of the cervix,
calculating a plane defined by the plane in which each point is equidistant from the center of mass of the fundus of uterus and the center of mass of the cervix,
determining two parts of the uterus, delimited by the plane, a distal part comprising the fundus of uterus and the anterior wall and a proximal part connected to the cervix,
calculating the center of mass of the distal part.

Advantageously and in accordance with the invention, the processing unit comprises a module for pre-calculating the projection of the 3D model from the 3D model and the predicted position and orientation.

Advantageously and in accordance with the invention, the processing unit comprises a module for receiving a 3D model of the scene generated from images captured by the endoscope, called peroperative 3D model, and a module for calculating the translation and scale factor between the 3D model of the target organ and the peroperative 3D model, configured for:
expressing the 3D model of the target organ and the peroperative 3D model in a common coordinate frame based on the position and orientation of the target organ on the current image with respect to the reference coordinate frame,
selecting an origin point in the common coordinate frame,
generating at least one radius extending from the origin point and extending in the direction of the optical axis of the endoscope,
calculating the distance between the origin and the intersection of each radius with the 3D model of the virtual organ,
calculating the distance between the origin and the intersection of each radius with the peroperative 3D model,
calculating the translation and scale factor from each distance between the origin and intersection of a radius with the 3D model of the virtual organ and each distance between the origin and intersection of said radius with the peroperative 3D model.

Advantageously and in accordance with the invention, the processing unit comprises a module for acquiring several images and a module for selecting, from among the images, an image with greater quality than the other images for the registration of the 3D model.

The advantages of these variants of the system for registration in accordance with the invention are analogous to the advantages of the previously described variants of the method for registration in accordance with the invention.

The invention also relates to a computer program product for registration [lacuna] computer program for the registration of a virtual three-dimensional model of a target organ, called 3D model, with at least one image of said target organ in a scene obtained by the endoscope, said computer program product comprising program code instructions in order to execute, when said computer program product is executed on a computer, the following steps:
a step of receiving the 3D model of the target organ,
a step of predicting a position and orientation of the target organ with respect to a reference coordinate frame of the scene in which the position and orientation of the endoscope are known, based on a reference position and orientation of the endoscope with respect to the scene,
a step of simulating a position and orientation of the 3D model based on said predicted position and said predicted orientation of the target organ,
a step of displaying at least one current image from the endoscope on a display device,
a step of superimposing, on at least one current image from the endoscope, a projection with semi-transparency of the 3D model based on the predicted position and orientation, on the display device, said projection being fixed with respect to the endoscope,
a step of receiving a command indicating an alignment between the projection with semi-transparency of the 3D model and the image of the target organ on the current image,
a step of calculating the position and orientation of the target organ on the current image with respect to the reference coordinate frame.

Advantageously and in accordance with the invention, the computer program product for registration in accordance with the invention comprises program code instructions for executing, when said computer program product is executed on a computer, the steps of the method for registration in accordance with the invention, in particular the steps of the method for registration of all of the previously described variants of the invention.

Advantageously and in accordance with the invention, the method for registration in accordance with the invention is configured to be implemented by a computer program product for registration in accordance with the invention.

The invention also relates to a system for registration, a method for registration and a computer program product for registration, which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic view of a system 10 for registration in accordance with one embodiment of the invention, integrated in a laparoscopic imaging system, in a first configuration.

FIG. 2 is a schematic view of a system 10 for registration in accordance with one embodiment of the invention, integrated in a laparoscopic imaging system, in a second configuration.

FIG. 3 is a schematic view of a method for registration in accordance with one embodiment of the invention.

FIG. 4 is a schematic view of a uterus forming a target organ of a method for registration in accordance with one embodiment of the invention.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

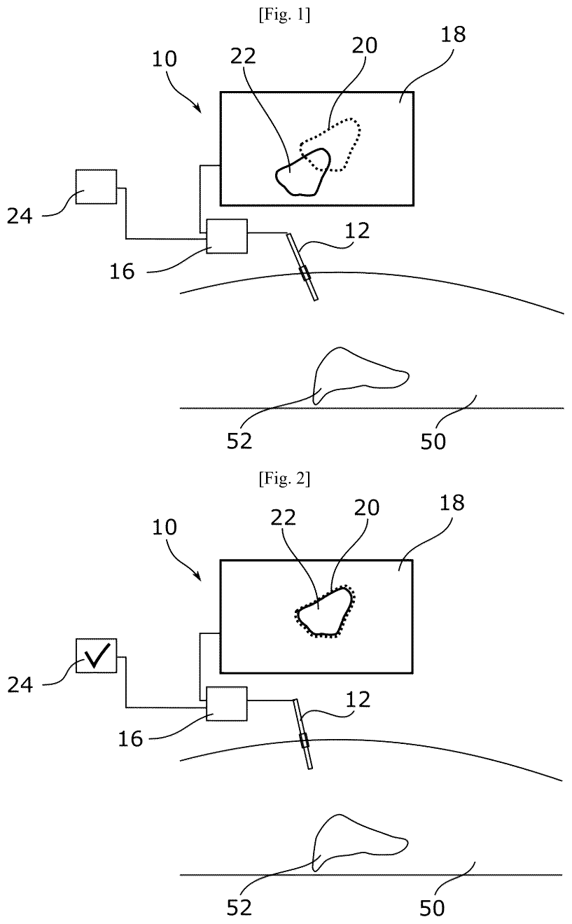

FIGS. 1 and 2 schematically show a system 10 for registration in accordance with one embodiment of the invention, integrated in a laparoscopic imaging system. The aim of the imaging system is to make it possible to acquire and output images taken in a cavity 50 in the body of the patient, in this case a cavity in the abdomen of a patient (or abdominal cavity 50), in particular within the scope of a laparoscopic procedure, for example laparoscopic surgery. The laparoscopic surgical operation can be intended, for example, for operation on a target organ 52.

The laparoscopic imaging system comprises a system 10 for registration in accordance with one embodiment of the invention, receiving images provided, for example, by an endoscope-type camera 12 configured to acquire images of the abdominal cavity 50 of the patient. The endoscope used within a laparoscopic operation is currently referred to as a laparoscope.

The system for registration comprises a plurality of modules making it possible to implement a method in accordance with the invention, brought together in this case in a processing unit 16. The processing unit 16 is, for example, a computer or electronic board comprising a processor, for example a processor dedicated to the processing of images of the method in accordance with the invention or even a general-purpose processor configured to execute, amongst a number of functions, in particular program instructions for execution of the steps of the method in accordance with the invention.

The images acquired by the endoscope 12 are displayed on a display device such as a display screen 18 of the system for registration being intended for an operator. The acquired images can be augmented, i.e. comprise additional information added by the laparoscopic imaging system, which can come from the system for registration or other devices.

In order to allow precise tracking of this additional information on the displayed image, the system 10 for registration is configured to determine the position and orientation of the target organ 52 in a reference coordinate frame of the scene so as to allow the displaying of the additional information based on the position and orientation of the target organ 52. In particular, one aim is to display a 3D model of the target organ on the image of the target organ 52 which requires the registration of the 3D model with the image of the target organ 52.

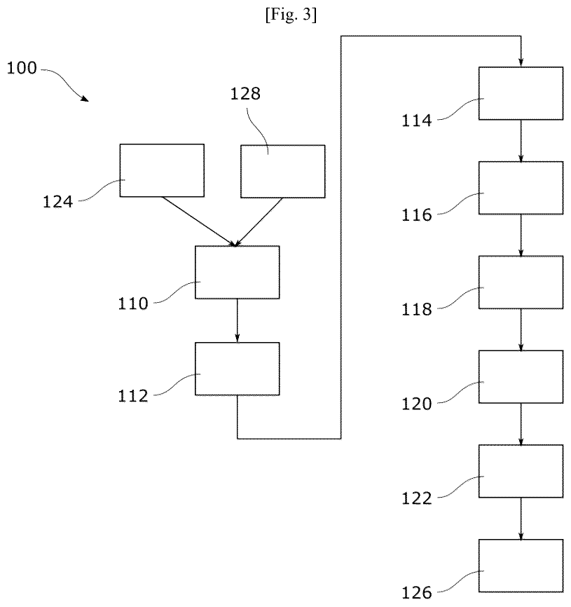

To do this, the system 10 for registration implements a method for registration as shown in FIG. 3.

The method 100 for registration comprises:
a step 110 of receiving the 3D model of the target organ by the processing unit 16, for example provided by an external computing device and having been obtained by medical imaging, in particular of the magnetic resonance imaging (MRI) type,
a step 112 of predicting, by the processing unit 16, a position and orientation of the target organ with respect to a reference coordinate frame of the scene in which the position and orientation of the endoscope are known, based on a predicted position and orientation of the endoscope with respect to the scene,
a step 114 of simulating, by the processing unit 16, a position and orientation of the 3D model based on said predicted position and said predicted orientation of the target organ.

These steps can be performed upstream of the medical and/or surgical procedure (preoperative phase).

The method 100 for registration also comprises the following steps, preferably implemented in parallel with the medical and/or surgical procedure (peroperative phase):
a step 116 of displaying at least one current image from the endoscope 12 on the display device 18,
a step 118 of superimposing, on at least one current image from the endoscope, a projection 20 with semi-transparency of the 3D model based on the predicted position and orientation, on the display device 18, said projection being fixed with respect to the endoscope 12. In FIGS. 1 and 2, the projection 20 with semi-transparency is shown in dotted lines and is fixed with respect to the image.

The method 100 for registration can comprise, upstream of the step 118 of superimposing and preferably in the preoperative phase, a step 128 of pre-calculating the projection of the 3D model from the 3D model and the predicted position and orientation. This phase makes it possible to prepare the projection of the 3D model which will be displayed on the display device 18.

Following this step 118 of superimposing, the operator in charge of manipulating the endoscope can attempt to align the image 22 of the target organ on the current image with the projection 20 with semi-transparency. FIG. 1 shows a first position in which the projection 20 with semi-transparency and the image 22 of the target organ are not aligned and FIG. 2 shows a second position in which the projection 20 with semi-transparency and the image 22 of the target organ are aligned. When the images are aligned in the opinion of the operator, he/she can then actuate a validation means, in particular a physical validation interface 24, for example comprising a foot-actuated pedal, so as to send a command indicating an alignment between the projection with semi-transparency of the 3D model and the image 22 of the target organ on the current image.

In accordance with another embodiment of the invention, the validation means can also be without any physical contact, for example with a sensor making it possible to detect a motion of the operator or to detect an audible command. In accordance with another embodiment of the invention, the validation means can also be automatic, in particular can comprise a validation module allowing automatic processing of the images and automatic detection of the alignment between the projection with semi-transparency of the 3D model and the image of the target organ on the current image, so as to suggest to the user that the alignment is complete or to directly send the command indicating such an alignment.

The method 100 for registration then comprises:
a step 120 of receiving the command indicating the alignment between the projection 20 with semi-transparency of the 3D model and the image 22 of the target organ on the current image,
a step 122 of calculating the position and orientation of the target organ on the current image with respect to the reference coordinate frame. The calculation is performed from the current image when the command indicating the alignment between the projection 20 and the image 22 of the target organ is received.

The method 100 for registration also comprises a step 124 of defining a canonical coordinate frame of the 3D model of the organ, said canonical coordinate frame being defined by an origin and three axes, preferably effected in the preoperative phase, and the step 112 of predicting a position and orientation of the target organ makes it possible to define a transformation of the 3D model of the organ between the canonical coordinate frame and the reference coordinate frame.

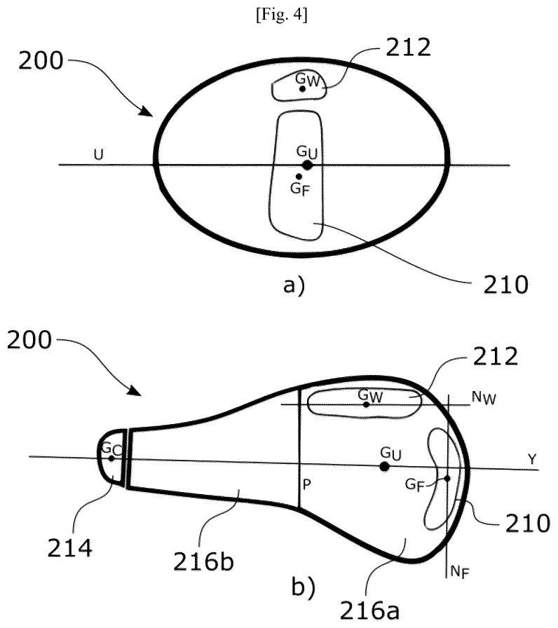

As shown in FIG. 4 schematically illustrating a uterus 200 in transverse section a) and longitudinal section b), when the target organ is a uterus 200, comprising in particular a fundus of uterus 210, an anterior wall 212 of the uterus and a cervix 214, the canonical coordinate frame is defined by an origin G_{U} forming the center of mass of a distal part of the uterus, a first left-right axis U of the uterus, a second axis Y connecting a center of mass G_{F} of the fundus of uterus and a center of mass G_{C} of the cervix and a third axis which is a scalar product of the first axis and second axis.

In particular, the step 124 of defining the canonical coordinate frame for a uterus 200 comprises:
a sub-step of calculating a principal axis of the medial part of the fundus of uterus 210, called fundus of uterus axis N_{F},
a sub-step of calculating a principal axis of the medial part of the anterior wall 212 of the uterus, called anterior wall axis N_{W},
a sub-step of calculating the left-right axis of the uterus (not shown) by the vectorial product of the fundus of uterus axis N_{F} by the anterior wall axis N_{W},
a sub-step of calculating the center of mass G_{F} of the fundus of uterus,
a sub-step of calculating the center of mass G_{C} of the cervix,
a sub-step of calculating a plane P defined by the plane in which each point is equidistant from the center of mass G_{F} of the fundus of uterus and the center of mass G_{C} of the cervix,
a sub-step of determining two parts of the uterus, delimited by the plane P, a distal part 216a comprising the fundus of uterus and the anterior wall and a proximal part 216b connected to the cervix,
a sub-step of calculating the center of mass G_{U} of the distal part.

Following these sub-steps, the origin and the axes necessary for defining the canonical coordinate frame are known.

The method 100 for registration can also comprises a step 126 of receiving a 3D model generated from images captured by the endoscope, called peroperative 3D model, and a step of calculating the translation and scale factor between the 3D model of the target organ and the peroperative 3D model, comprising:
a sub-step of expressing the 3D model of the target organ and the peroperative 3D model in a common coordinate frame based on the position and orientation of the target organ on the current image with respect to the reference coordinate frame,
a sub-step of selecting an origin point in the common coordinate frame,
a sub-step of generating at least one radius extending from the origin point and extending in the direction of the optical axis of the endoscope,
a sub-step of calculating the distance between the origin and the intersection of each radius with the 3D model of the virtual organ,
a sub-step of calculating the distance between the origin and the intersection of each radius with the peroperative 3D model,
a sub-step of calculating the translation and scale factor from each distance between the origin and intersection of a radius with the 3D model of the virtual organ and each distance between the origin and intersection of said radius with the peroperative 3D model.

The endoscope 12 can be configured to acquire several images and the method 100 for registration can also comprise a step of selecting, from among the images, an image with greater quality than the other images for the registration of the 3D model.

The invention is not limited to the embodiments described. The system for registration can be integrated into different types of imaging, in particular other types of medical imaging, in particular when a position and orientation of the target organ with respect to the endoscope can be predicted. Furthermore, the target organ can be different: in a laparoscopic context, other organs in the abdomen possibly being operated on by laparoscopy can be target organs, for example a liver or a kidney.

1. A method for registration of a virtual three-dimensional (3D) model of a target organ, with at least one image of said target organ in a scene obtained by an endoscope, comprising:
a step of receiving the 3D model of the target organ,
a step of predicting a position and orientation of the target organ with respect to a reference coordinate frame of the scene in which the position and orientation of the endoscope are known, based on a reference position and orientation of the endoscope with respect to the scene,
a step of simulating a position and orientation of the 3D model based on said predicted position and said predicted orientation of the target organ,
a step of displaying at least one current image from the endoscope on a display device,
a step of superimposing, on at least one current image from the endoscope, a projection with semi-transparency of the 3D model based on the predicted position and orientation, on the display device, said projection being fixed with respect to the endoscope,
a step of receiving a command indicating an alignment between the projection with semi-transparency of the 3D model and the image of the target organ on the current image,
a step of calculating the position and orientation of the target organ on the current image with respect to the reference coordinate frame.

2. The method for registration as claimed in claim 1, further comprising a step of defining a canonical coordinate frame of the 3D model of the organ, said canonical coordinate frame being defined by an origin and three axes, and in that the step of predicting a position and orientation of the target organ makes it possible to define a transformation of the 3D model of the organ between the canonical coordinate frame and the reference coordinate frame.

3. The method for registration as claimed in claim 2, characterized in that the target organ is a uterus comprising in particular a fundus of uterus, an anterior wall of the uterus and a cervix, and the canonical coordinate frame is defined by an origin forming the center of mass of a distal part of the uterus, a first left-right axis of the uterus, a second axis connecting a center of mass of the fundus of uterus and a center of mass of the cervix and a third axis which is a scalar product of the first axis and second axis.

4. The method for registration as claimed in claim 3, characterized in that the step of defining the canonical coordinate frame comprises:
a sub-step of calculating a principal axis of the medial part of the fundus of uterus, called fundus of uterus axis (NF),
sub-step of calculating a principal axis of the medial part of the anterior wall of the uterus, called anterior wall axis (NW),
a sub-step of calculating the left-right axis of the uterus by the vectorial product of the fundus of uterus axis (NF) by the anterior wall axis (NW),
a sub-step of calculating the center of mass (GF) of the fundus of uterus,
a sub-step of calculating the center of mass (GC) of the cervix,
a sub-step of calculating a plane (P) defined by the plane in which each point is equidistant from the center of mass (GF) of the fundus of uterus and the center of mass (GC) of the cervix,
a sub-step of determining two parts of the uterus, delimited by the plane (P), a distal part comprising the fundus of uterus and the anterior wall and a proximal part connected to the cervix,
a sub-step of calculating the center of mass (GU) of the distal part.

5. The method for registration as claimed in claim 1, further comprising a step of pre-calculating the projection of the 3D model from the 3D model and the predicted position and orientation, upstream of the step of superimposing said projection on at least one current image from the endoscope.

6. The method for registration as claimed in claim 1, further comprising a step of receiving a 3D model of the scene generated from images captured by the endoscope, called peroperative 3D model, and a step of calculating the translation and scale factor between the 3D model of the target organ and the peroperative 3D model, comprising:
a sub-step of expressing the 3D model of the target organ and the peroperative 3D model in a common coordinate frame based on the position and orientation of the target organ on the current image with respect to the reference coordinate frame,
a sub-step of selecting an origin point in the common coordinate frame,
a sub-step of generating at least one radius extending from the origin point and extending in the direction of the optical axis of the endoscope,
a sub-step of calculating the distance between the origin and the intersection of each radius with the 3D model of the virtual organ,
a sub-step of calculating the distance between the origin and the intersection of each radius with the peroperative 3D model,
a sub-step of calculating the translation and scale factor from each distance between the origin and intersection of a radius with the 3D model of the virtual organ and each distance between the origin and intersection of said radius with the peroperative 3D model.

7. The method for registration as claimed in claim 1, further comprising an acquisition of several images and a step of selecting, from among the images, an image with greater quality than the other images for the registration of the 3D model.

8. A system for registration of a virtual three-dimensional model of a target organ with an image of said target organ, comprising:
an endoscope configured to capture said image,
a display device configured to display said image,
a validation means configured to provide a command indicating an alignment between a projection with semi-transparency of the 3D model and the image of the target organ,
a processing unit
the processing unit comprising:
a module for receiving the 3D model of the target organ,
a module for predicting a position and orientation of the target organ with respect to a reference coordinate frame of the scene in which the position and orientation of the endoscope are known, based on a reference position and orientation of the endoscope with respect to the scene,
a module for simulating a position and orientation of the 3D model based on said predicted position and said predicted orientation of the target organ,
a module for displaying at least one current image from the endoscope on a display device,
a module for superimposing, on at least one current image from the endoscope, a projection with semi-transparency of the 3D model based on the predicted position and orientation, on the display device, said projection being fixed with respect to the endoscope,
a module for receiving a command indicating an alignment between the projection with semi-transparency of the 3D model and the image of the target organ on the current image,
a module for calculating the position and orientation of the target organ on the current image with respect to the reference coordinate frame.

9. The system for registration as claimed in claim 8, characterized in that the validation means is a physical validation interface comprising a pedal intended to be actuated by a foot of an operator.

10. The system for registration as claimed in claims 8, characterized in that the processing unit comprises a module for defining a canonical coordinate frame of the 3D model of the organ, said canonical coordinate frame being defined by an origin and three axes, and in that the module for predicting a position and orientation of the target organ makes it possible to define a transformation of the 3D model of the organ between the canonical coordinate frame and the reference coordinate frame.

11. The system for registration as claimed in claims 8, characterized in that the target organ is a uterus comprising in particular a fundus of uterus an anterior wall of the uterus and a cervix, and the canonical coordinate frame is defined by an origin forming the center of mass of a distal part of the uterus, a first left-right axis of the uterus, a second axis connecting a center of mass of the fundus of uterus and a center of mass of the cervix and a third axis which is a scalar product of the first axis and second axis.

12. The system for registration as claimed in claim 8, characterized in that the module for defining the canonical coordinate frame is configured for:
calculating a principal axis of the medial part of the fundus of uterus, called fundus of uterus axis (NF),
calculating a principal axis of the medial part of the anterior wall of the uterus, called anterior wall axis (NW),
calculating the left-right axis of the uterus by the vectorial product of the fundus of uterus axis (NF) by the anterior wall axis (NW),
calculating the center of mass (GF) of the fundus of uterus,
calculating the center of mass (GC) of the cervix,
calculating a plane (P) defined by the plane in which each point is equidistant from the center of mass (GF) of the fundus of uterus and the center of mass (GC) of the cervix,
determining two parts of the uterus, delimited by the plane (P), a distal part comprising the fundus of uterus and the anterior wall and a proximal part connected to the cervix,
calculating the center of mass (GU) of the distal part.

13. The system for registration as claimed in claim 8, characterized in that the processing unit comprises a module for pre-calculating the projection of the 3D model from the 3D model and the predicted position and orientation.

14. The system for registration as claimed in claim 8, characterized in that the processing unit comprises a module for receiving a 3D model of the scene generated from images captured by the endoscope, called peroperative 3D model, and a module for calculating the translation and scale factor between the 3D model of the target organ and the peroperative 3D model, configured for:
expressing the 3D model of the target organ and the peroperative 3D model in a common coordinate frame based on the position and orientation of the target organ on the current image with respect to the reference coordinate frame,
selecting an origin point in the common coordinate frame,
generating at least one radius extending from the origin point and extending in the direction of the optical axis of the endoscope,
calculating the distance between the origin and the intersection of each radius with the 3D model of the virtual organ,
calculating the distance between the origin and the intersection of each radius with the peroperative 3D model,
calculating the translation and scale factor from each distance between the origin and intersection of a radius with the 3D model of the virtual organ and each distance between the origin and intersection of said radius with the peroperative 3D model.

15. The system for registration as claimed in claim 8, characterized in that the processing unit comprises a module for acquiring several images and a module for selecting, from among the images, an image with greater quality than the other images for the registration of the 3D model.

16. A computer program product for the registration of a virtual three-dimensional (3D) model of a target organ, with at least one image of said target organ in a scene obtained by an endoscope, said computer program product comprising program code instructions in order to execute, when said computer program product is executed on a computer, the following steps:
a step of receiving the 3D model of the target organ,
a step of predicting a position and orientation of the target organ with respect to a reference coordinate frame of the scene in which the position and orientation of the endoscope are known, based on a reference position and orientation of the endoscope with respect to the scene,
a step of simulating a position and orientation of the 3D model based on said predicted position and said predicted orientation of the target organ,
a step of displaying at least one current image from the endoscope on a display device,
a step of superimposing, on at least one current image from the endoscope, a projection with semi-transparency of the 3D model based on the predicted position and orientation, on the display device, said projection being fixed with respect to the endoscope,
a step of receiving a command indicating an alignment between the projection with semi-transparency of the 3D model and the image of the target organ on the current image,
a step of calculating the position and orientation of the target organ on the current image with respect to the reference coordinate frame.
